(19) United States
(12) Patent Application Publication
(10) Pub. No.: US 2003/0047215 A1
(43) Pub. Date: Mar. 13, 2003

(54) External cross over valve

(76) Inventors: Kurt Drewelow, Aitken, MN (US); Corey Krantz, Baxter, MN (US)

Correspondence Address: John Vasuta, c/o Sand & Sebolt, P.O. Box 1151, Hudson, OH, 44236, US

(21) Appl. No.: 10/192,545

(22) Filed: Jul. 9, 2002

Related U.S. Application Data
(60) Provisional application No. 60/304,261, filed on Jul. 10, 2001.

(51) Int. Cl. F17D 1/00

(52) U.S. Cl. 137/517

(57) ABSTRACT

An improved valve and manifold for use in conjunction with inflatable devices such as rigid hull inflatable boats or ribs, life rafts, escape slides, white water rafts, kayaks, etc. The invention is specifically an external cross over valve for inflatable rafts and the like where the valve fluidly connects at least two separate compartments in the inflatable device thereby allowing inflation of the multiple compartments while also providing control of fluid flow therebetween.

### CROSS REFERENCE

Priority is claimed to U.S. Provisional Patent Application No. 60/304,261.

### BACKGROUND OF THE INVENTION

1. Technical Field

The invention relates to valves for inflatable devices such as rigid hull inflatable boats (ribs) or other military use boats, inflatable dinghies, life rafts, escape slides, white water rafts, kayaks, etc., and more particularly an external cross over valve for inflatable rafts and the like where the valve fluidly connects at least two separate compartments in the inflatable device thereby allowing inflation of the multiple compartments while also providing control of fluid flow therebetween.

2. Background Information

For years, numerous different types of inflatable devices have been used for a variety of reasons. For instance, inflatable life rafts have been regularly provided on large aircrafts and water vessels for decades including those used by the military. These inflatable life rafts provide the necessary flotation vessels as would be needed by the passengers of the aircraft or water vessel should the aircraft crash or otherwise end up in water, or should the water vessel sink.

Rigid hull inflatable boats or ribs have also become extremely popular. These and other like boats with inflatable portions coupled to rigid portions (in one case fiber glass or like material hulls are coupled with inflatable tubes to define the watercraft). These ribs have increasingly become the inflatable vessel of choice in the military for many operations. In addition, civilian use has also rapidly expanded because these ribs work well as dinghies due to the rigid hull coupled to peripheral inflatable tubes that can readily bump up against docks, other boats and the like without causing damage.

For safety reasons, and also in certain instances as required by law, ribs or inflatable rafts for the military or civilian aircraft or watercraft use are formed of at least two distinct and separate inflatable chambers or compartments. These chambers remain completely separate so inflation thereof can be controlled, and so that deflation in the case of a rupture of one of the compartments will not deflate the entire raft but only that one compartment. As a result, inflation valves and mechanisms, often called fill valves, are often provided for each and every compartment or chamber. This requires expensive, bulky equipment attached to each compartment.

### SUMMARY OF THE INVENTION

The present invention is an improved valve assembly called an external cross over valve assembly capable of controlled inflation of each compartment in an inflatable device coupled with a safety feature prohibiting deflation of all compartments when only one has a hole causing deflation thereof.

These objectives and advantages are obtained by the improved external cross over valve of the present invention, the general nature of which may be stated as including an external cross over valve for inflatable rafts and the like where the valve fluidly connects at least two separate compartments in the inflatable device thereby allowing inflation of the multiple compartments while also providing control of fluid flow therebetween.

### BRIEF DESCRIPTION OF THE DRAWINGS

The preferred embodiment of the invention, illustrative of the best mode in which applicant has contemplated applying the principles, is set forth in the following description and is shown in the drawings and is particularly and distinctly pointed out and set forth in the appended claims.

FIG. 1 is a sectional view of a manifold of the present invention with a valve in an open position in one end thereof;

FIG. 2 is a partial sectional view of the valve of the present invention in a closed position; and

FIG. 3 is a partial sectional view of an alternative embodiment of the present invention in a closed position.

Similar numerals refer to similar parts throughout the drawings.

### DESCRIPTION OF THE PREFERRED EMBODIMENT

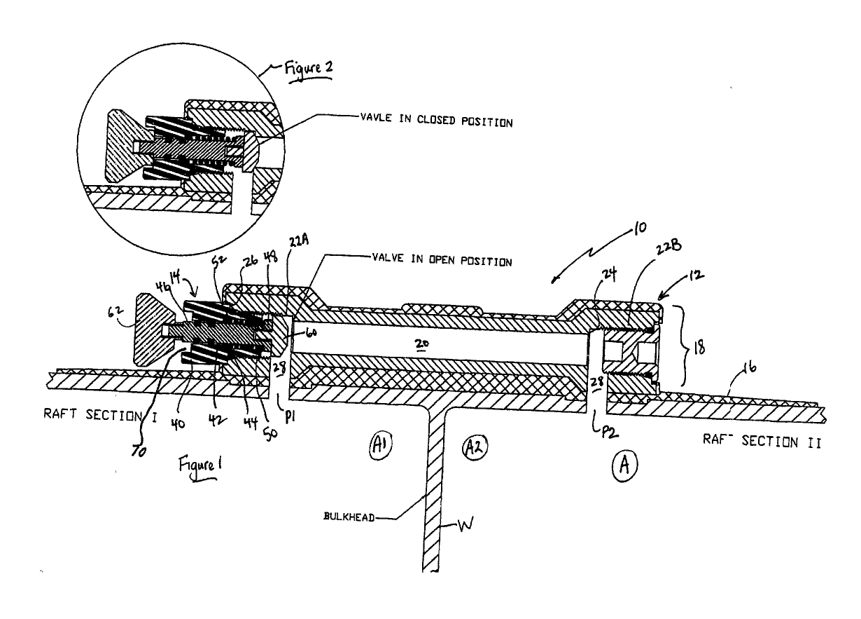

The improved external cross over valve assembly 10 for use in inflation devices A such as rigid hull inflatable boats or ribs, life rafts, escape slides, white water rafts, kayaks, and the like is shown in the Figures. This external cross over valve assembly 10 is adhered to the inflatable device A via adhesive, glue, ultrasonic welding or other methods known by one of skill in the art, where the inflatable device A includes a plurality of compartments or chambers (in this case as shown in FIG. 1, a first compartment A1 and a second compartment A2) each separated by a wall or bulkhead W. Each of the raft sections or compartments includes an access port P (in the embodiment shown an access port P1 and access port P2).

One inflation or fill valve is provided either separate from the improved external cross over valve, or incorporated therein, but in either case only one inflation or fill valve is needed to inflate the entire inflatable device A. In the embodiment shown, the external cross over valve does nit include a fill valve and is used to “bridge” bulkhead W in between compartments A1 and A2.

This improved external cross over valve assembly 10 includes a manifold 12 and at least one valve 14. Manifold 12 is a rubber, plastic or other flexible material that is preferably in a substantially planar configuration of preferably an oval shape although other shapes and configurations are contemplated. Manifold 12 has an inner side or face and an outer side or face whereby the inner face is attachable as noted above via cement, adhesive, glue, hermetic welding or the like to an inflatable device A with a plurality of compartments or chambers whereby the manifold is attached over access port P1 and access port P2 and spans the bulkhead W.

The outer face of the manifold 12 includes a cross over assembly 18 extending therefrom. This cross over assembly 18 includes a central passage 20 with a plurality of end ports 22 therein (in the embodiment shown: end ports 22A and 22B). Each end port 22 is a threaded port of a larger diameter than central passage 20 such that the end port terminates at its innermost end in a shoulder 24 around the central passage where the shoulder allows for seating of a valve head as described below. The outermost end of each end port 22 also includes a valve body seating shoulder 26.

Each end port 22 also includes a flow passage 28 that intersects with the end port in such a manner to allow the seating and unseating of the valve against the shoulder 24 to close and open the fluid flow between the flow passage 28 and the central passage 20.

These flow passages 28 are aligned with access ports P1 and P2 such that fluid may flow therethrough. This is shown in FIG. 1.

A valve 14 may be insertable within an end port as shown in FIG. 1 at end port 22A. End port 22B is shown with a plug therein.

Each valve 14 includes a valve body 40 with a central aperture 42 axially therethrough. The valve body 40 includes external threads for threading the valve body into its respective end port and the threads therein as described above.

The central aperture 42 has a first or front end that is inserted into the manifold, and a second or back end that is not inserted into the manifold in use, and the aperture further includes a spring shoulder 44 in between the ends. A valve stem 46 is insertable into the central aperture 42 and the valve stem includes a head portion 48 with a shoulder 50 thereon. A spring 52 is positioned in between the shoulders 44 and 50 and biases the stem toward first end. The valve stem also includes one or more circumferential grooves in which seals may be positioned.

A tip or poppet 60 is attachable to the head portion 48 of the stem 46. In the most preferred embodiment, the tip includes a top surface that is perpendicular to the stem axis where this top flat surface includes a tapered or sloped area circumferentially therearound. This allows for a tight seal as spring 52 actuates the tip into tight sealing contact with shoulder 24 around central passage 20.

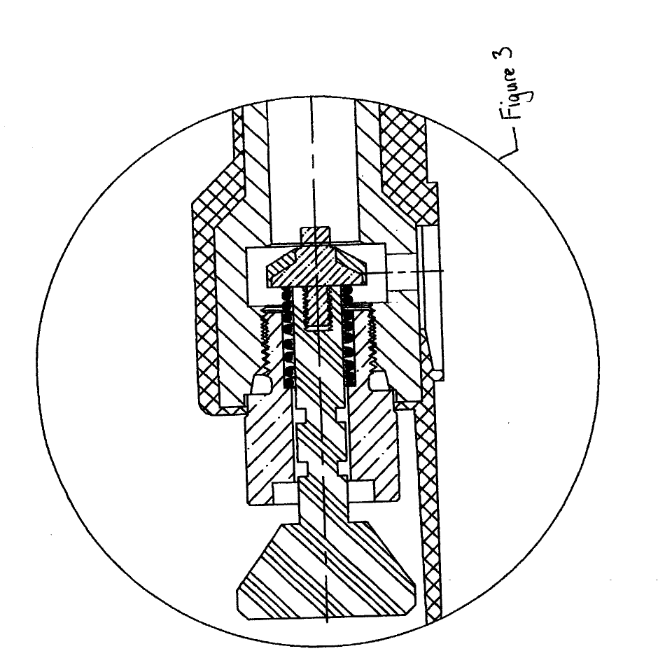

At the opposite end of stem 46 as tip 60 is a handle 62 that allows users to pull valve stem 46 such that the tip 60 unseats from shoulder 24 thereby allowing for fluid flow from flow passages 28 to central passage 20. In an alternative embodiment, the valve stem 46 and handle 62 may be one piece as shown in FIG. 3. FIG. 3 also show a slightly different stem design where the stem does not include a head portion 48 such that the spring presses directly against the poppet or tip 60. It is also contemplated that the embodiment of FIG. 2 may incorporate one but not both of these alternative features.

FIG. 3 also shows a different tip or poppet 60 which is a two piece design, generally a more rigid material such as metal covered by a better sealing material such as a rubber, plastic or polymer material.

The open position when the handle is pulled such that the spring bias is overcome and the tip unseats from the shoulder is shown in FIG. 1, while the closed position when the spring bias is allowed to force the tip into a seated positioned against the shoulder thereby blocking fluid flow is shown in FIG. 2.

The valve may be held open if the handle is turned ninety degrees or so. This is because the of slot 70. FIG. 2 shows the handle seated within slot 70, while FIGS. 1 and 3 show it pulled out of the slot. Since the slot is rectangular, and the handle is milled at its smaller diameter end to also be rectangular, the valve will only close when the handle is seated within the slot and this will only occur when the rectangular handle is aligned with the rectangular slot. Thus, if it is desirable to keep the valve open, the handle is pulled and twisted thereby un-aligning the rectangular portion of the handle from the rectangular slot.

A second cross over valve assembly could be placed in the end port 22B where a plug is currently shown should it be desired that two valves be opened to allow fluid flow between compartments. Alternatively, a fill valve or inflation valve may be attached here, or the fill or inflation valve may be attached into a center port 80 as shown in hidden lines as an option on FIG. 1.

Accordingly, the improved invention is simplified, provides an effective, safe, inexpensive, and efficient device which achieves all the enumerated objectives, provides for eliminating difficulties encountered with prior devices, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed. Moreover, the description and illustration of the invention is by way of example, and the scope of the invention is not limited to the exact details shown or described.

Having now described the features, discoveries and principles of the invention, the manner in which the improved invention is constructed and used, the characteristics of the construction, and the advantageous, new and useful results obtained, the new and useful structures, devices, elements, arrangements, parts and combinations, are set forth in the appended claims.

We claim:

1. A valve for interconnecting a first fluid compartment to a second fluid compartment in an inflatable device, the valve comprising:
a manifold attachable to the inflatable device, the manifold including a central passage therein with a fluid flow passage connected to the first fluid compartment and a fluid flow passage connected to the second fluid compartment; and
a valve biased to block fluid flow through the central passage where the valve is openable to provide for fluid flow.
